(19) United States
(12) Patent Application Publication
(10) Pub. No.: US 2021/0366625 A1
(43) Pub. Date: Nov. 25, 2021

(54) MITIGATING NUCLEAR FUEL DAMAGE: NUCLEAR REACTOR AND/OR INCIDENT OR ACCIDENT

(71) Applicant: A.Robert Abboud and Company, Fox River Grove, IL (US)

(72) Inventor: Robert G. Abboud, Barrington Hills, IL (US)

(21) Appl. No.: 16/499,525

(22) PCT Filed: Oct. 3, 2018
(86) PCT No.: PCT/US18/54268

§ 371 Date: Sep. 30, 2019

Related U.S. Application Data
(60) Provisional application No. 62/478,024, filed on Mar. 28, 2017.

(51) Int. Cl. G21F 1/06; G21F 9/30; G21F 5/10; G21F 1/08

(52) U.S. Cl. CPC G21F 1/06; G21F 9/302; G21F 1/08; G21F 5/10; G21F 9/305

(57) ABSTRACT

Composition, manufactures, and processes of making and using them, consisting essentially of a neutron absorbent, having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml. The composition can be located for release responsive to a loss of normal heat sink event and/or a loss of normal coolant event in a quantity sufficient, to palliate the loss of the normal heat sink event and/or the loss of normal coolant event.

### CROSS REFERENCE

This application claims the benefit and priority from of U.S. Provisional Patent Application No. 62/478,024, filed on Mar. 28, 2017, which is incorporated by reference in its entirety. This application also claims the benefit and priority from, and incorporates by reference, PCT/US2018/024612 and PCT/US2018/024682 and PCT/US2018/034964.

### BACKGROUND

Nuclear reactors are in wide use today throughout the globe and perform a variety of functions including the production of electric power, thermal energy for heating and industrial processes, research and development, the production of industrial radio nuclides, and propulsion of ships and spacecraft. In all of these functions nuclear safety is the primary design and operation priority. Nuclear safety poses, of course, important technological problems. This includes ensuring that radionuclides, which are a byproduct of nuclear fission and generated by the exposure of elements to the neutron flux, are not released to the environment. This, in turn, includes protecting the fuel by ensuring a suitable thermal heat sink exists continuously and that the fuel is properly supported mechanically. Much of the cost of current generation nuclear reactors pertaining to operating these reactors is related to protecting against the loss of heat sink and subsequent damage of the fuel.

Nuclear reactors are designed to generate thermal energy and the transfer this energy via a coolant or transfer medium to devices for creating useful work (e.g., electricity) and ultimately to a heat sink such as the earth, body of water, air, or space. A typical nuclear reactor configuration comprises a nuclear reactor core containing its fuel, a reactor vessel which contains the core and provides a hydraulic circuit in which to circulate coolant to transfer thermal energy for useful work and to the ultimate heat sink, and a containment vessel surrounding the entire system in order to contain radionuclides and coolant in the event of a reactor accident including the failure of the coolant hydraulic circuit.

The relationship between the nuclear reactor fuel in its core and the heat sink is particularly important in that the loss of this connection can rapidity lead to high fuel temperatures and ultimately failure of the fuel and fuel components. This loss of normal connection to the heat sink is typically referred to as a loss of cool and accident, LOCA. LOCA events can rapidly lead to fuel damage. Failure of the fuel will result in costly damage to the reactor and may release radio nuclides to the environment.

Unlike fossil fueled systems, nuclear reactors have radionuclide decay heat sources in the fuel which persist for years after the nuclear chain reaction (e.g. fission) is shut down. The loss of the connection to the heat sink, or LOCA, will therefore result in fuel damage, even after shutdown. The core damage events at Fukushima in Japan, Three Mile Island in the United States, Chernobyl in Russia, and Windscale in England are good examples of this condition. Many died from radiation exposure in the efforts to react to the Chernobyl nuclear accident or incident.

Present day systems rely on liquid coolants (typically water or sodium) or gas coolants (e.g. carbon dioxide). While these coolants are normally effective heat transfer mechanisms to connect the nuclear reactor fuel to the heat sink, they require substantial support components such as pipes, pumps, valves, etc. and auxiliary power (i.e., electricity or steam) to support these components for pumping of the coolant, management of valves, and associated instrumentation. These support components and auxiliary power sources are prone to failure resulting in the loss of the coolant and disconnection of the fuel from the reactor heat sink.

Coolant system failures can be the result of external forces such as seismic activity or terrorism, or they can be a result of design or manufacturing flaws resulting in structural failure of the hydraulic system or electrical or control failures which prevent coolant from flowing through the hydraulic circuit. In either case the result is the same: the nuclear fuel becomes disconnected from the heat sink and thus its temperature rises dramatically to the point of fuel degradation and failure leading to the release of radionuclides into the environment.

Present day nuclear reactors employ a variety of safety systems designed specifically protect the reactor coolant systems and provide a defense in depth strategy using auxiliary cooling and multiple sources of auxiliary power. These multiple levels of backup equipment substantially increase the cost of nuclear reactor construction and reactor accidents involving fuel damage have continued to occur.

As evident from the Fukushima, Three Mile Island, Chernobyl, and Windscale incidents, there is a need for an alternate form of backup fuel-to-heat sink thermal connection be developed. Relatedly, a need exists for an alternative way to palliate the loss of the normal heat sink event and/or the loss of normal coolant event.

### SUMMARY

Responsive to these and other needs, a composition is added to a nuclear accident or incident, such as that in reactor core's environment in the event of a loss of heat sink and/or loss of coolant accident, e.g., to reestablish the fuel-to-heat sink thermal connection, provide added mechanical support to the fuel, and limit/or further thermal energy production by the fuel by preventing further fission events from occurring.

The composition, or additive, can include particles comprising (and in other embodiments consisting essentially of) a non-gaseous neutron absorbent having a neutron absorption cross section greater than Boron (e.g., comprising at least 19.7% of Boron-10 isotope) and a thermal conductor (e.g., having a thermal conductivity of at least 10% of water thermal conductivity at 100 degrees C. at sea level), combined to have a density such as that of at least 0.9982 g/mL and not of more than 2.0 g/ml. The particles can, but need not, be glass, ceramic, an aggregate, or some combination of them. The particles can, but need not always, be a composite.

The technical effects of the compositions disclosed herein can include stabilizing the nuclear material while absorbing neutronic radiation and conveying heat away from the nuclear material. It is believed that such compositions represent an advance in comparison with conventional coolants, such as water.

The teachings herein are directed to solid particles each comprised of a glass bead, (e.g., rounded, ellipsoid, generally not pointy) typically coated with a thin metallic film, and containing at least one gas bubble in order to control density.

Illustratively with respect to reactors, injection of the particles into the reactor core during the accident sequence can be carried out to reestablish the connection between the fuel and the heat sink and to quench the nuclear reaction/fission process. This will substantially reduce the temperature of the fuel and prevent fuel damage or mitigate fuel damage which has already occurred.

The particles can have high thermal conductivity and high heat capacity along with a relatively high melting point. En masse, the particles can provide a thermal pathway for decay heat energy to escape the nuclear reactor fuel and ultimately be transmitted to a large heat sink such as the reactor structure and foundation.

Use of these particles provides the reactor operator with an alternative or supplemental cooling strategy in the event of a loss of coolant accident which would typically have led to fuel damage or worse. The use of the particles gives the operator substantially increased time to reflood the nuclear reactor core with traditional coolants, such as water or sodium, and ultimately terminate the accident sequence.

These particles are sized and shaped such that they flow relatively easily and can fill some or all of the reactor core cavity when needed. The particles can be injected, carried along by an additional coolant medium such as liquid or gas, or flow by gravity into the reactor core when needed.

In order to properly flow, the particles can maintain a relatively low static coefficient of friction between each other and the nuclear reactor structures. They can also remain relatively hard and non-deformable. However, when exposed to high stress, the particles can be suitably deformed in order that they provide a cushion for the nuclear reactor fuel in the event of displacement shocks. As discussed below, this can be facilitated in some cases by partial deformation of the particles and/or by a non-Newtonian behavior of the particles as a group.

The particles can be designed such that when grouped together their density is approximately that of the primary coolant of the nuclear reactor, such as water. This ensures that use of the particles will not overstress the normal structural components and vessels of the nuclear reactor.

In addition, the particles can be designed such that their maximum packing density is in the range of approximately 70%. This provides spaces in between the particles when packed in the nuclear reactor core allowing the primary coolant, such as water, to be reintroduced into the reactor core as the recovery from the accident progresses.

Loss of coolant and loss of heat sink events are many times related to or accompanied by seismic or other system vibration issues can require additional support of the nuclear reactor fuel. Nuclear reactor fuel is also more susceptible to damage and deformation when overheated such as during a Loss of Coolant Accident (LOCA) event. Injection of the particles into the reactor core provides substantially improved structural support of the reactor fuel and prevents or mitigates relocation of radio nuclides.

Because the timing of reactor accidents involving loss of coolant or loss of heat sink events is rarely predicted by conventional means, a suitable inventory of the particles can be made available either onsite or relatively close by for rapid use by the nuclear reactor operator should the need arise.

Storage of the particles can be within the containment vessel of the nuclear reactor located the position such that the particles can be injected into the reactor core at the command of the operator, the control computer system and instrumentation, or responsive to physical conditions such as through a burst disk or check valve driven by system pressure or gravity. Alternatively, the particles can be delivered from a storage inventory to the reactor vessel via a robotic or drone system. The use of robotics or drones may be particularly useful in cases where substantial reactor damage has already occurred such as in the latter stages of the Fukushima or Chernobyl type accidents (e.g., where the reactor chamber has been breached or is intentionally breached to allow insertion of the particles into the core

Ideally, the particles are to be injected into the reactor core prior to the onset of nuclear fuel damage, when access to the fuel and coolant channels is still available. This would be in the time scale where the operator or the reactor control system had expended most other engineered safeguard options including safety injection and attempts to restore reactor core cooling through normal or backup means using the normal coolant.

While the use of the particles may render the nuclear reactor inoperable for some time after the accident, the use of the particles would not always cause permanent damage to the reactor system(s) and thus the system would not always be declared a total loss depending on the embodiment and techniques necessary for the removal of the particles. The particles may be removed by hydraulic or robotic means using conventional hydraulic or gas vacuuming systems. Because the particles allow for the simultaneous presence of the normal coolant liquid (e.g. water), the removal of the particles can occur simultaneous with the addition of coolant, thus maintaining heat sink to the fuel at all times during the recovery phase.

Depending on the implementation, there is apparatus, manufactures, composition of matter, and processes for using and processes for making the foregoing, as well as products produced thereby and necessary intermediates of the foregoing.

### INDUSTRIAL APPLICABILITY

Depending on the implementation, industrial applicability is illustratively directed to nuclear science, nuclear engineering, material science, and mechanical engineering. These may be related to use of nuclear material for energy production such as nuclear fuel, nuclear reactor cores, nuclear reactor systems, as well as industries operating in cooperation with the foregoing.

### INCORPORATION BY REFERENCE

All publications, patents, and patent applications mentioned in this specification are herein incorporated by reference to the same extent as if each individual publication, patent, or patent application was specifically and individually indicated incorporated herein.

### DRAWINGS

FIG. 1 is a schematic indication of a typical nuclear reactor system for the production of electricity as prior art.

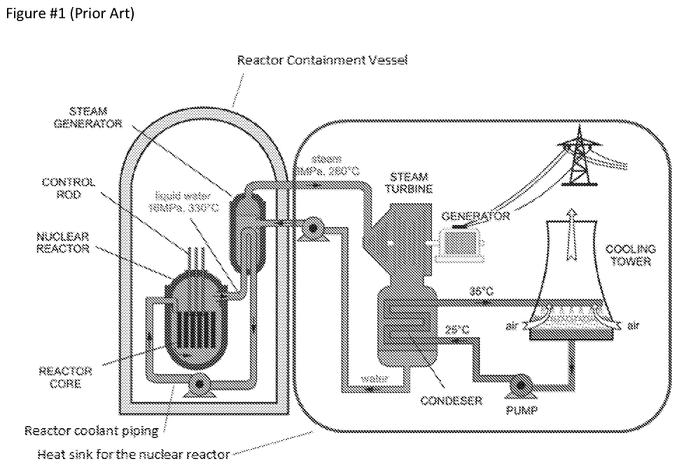

FIG. 2 is a schematic indication of a nuclear reactor fuel core and pressure vessel assembly as prior art.

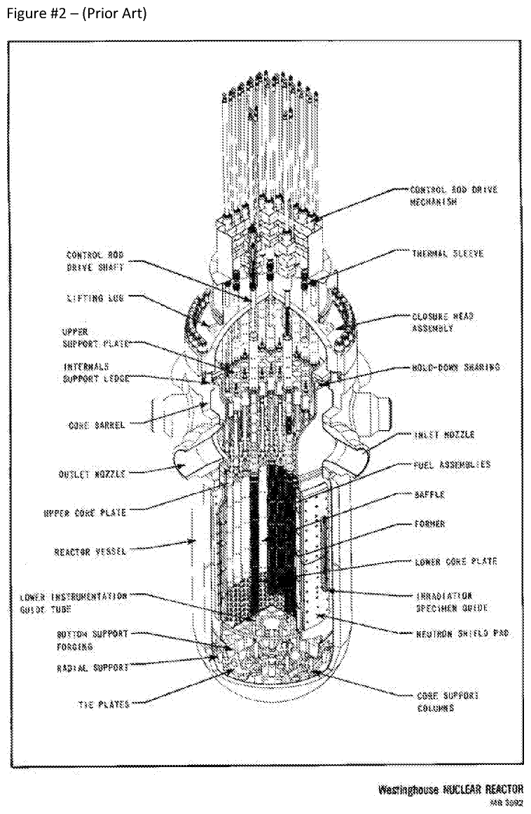

FIG. 3 is a schematic indication of one possible configurations of a particle involving a core.

FIG. 4 is an illustration of another possible configuration of a particle involving a foam.

FIG. 5 is an illustration of another possible configuration of a particle involving an aggregate.

FIG. 6 is an illustration of close pack orientation.

FIG. 7 is an illustration of a nuclear reactor system containing particles located in storage in the reactor containment and a reactor core

FIG. 8 is an illustration of a nuclear reactor system containing particles relocated into the reactor core and surrounding the nuclear fuel materials.

FIG. 9 is an illustration of a robotic vehicle and handling transport system containing particles to be relocated into the reactor core and surrounding the nuclear fuel materials.

FIG. 10 is an illustration of a robotic air drone/helicopter handling transport system containing particles to be relocated into the reactor core and surrounding the nuclear fuel materials.

FIG. 11 is an illustration of a logic for release or injection of the composition.

FIG. 12 is an illustration of a control system.

### MODES

As mentioned above a composition is employed as an additive to a nuclear reactor core environment prior to or in a post-accident situation. The additive is located into the space between a nuclear fuel material and a reactor vessel. The additive, for example, can comprise (and in other embodiments consisting essentially of) particles having a composite material including a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml. While the neutron absorption cross section can be provided by Boron comprising at least 19.7% of Boron-10 isotope, this need not always be the case as the neutron absorption cross section can be provided by any material with a thermal neutron capture cross-section of greater than 0.300 barns. Examples of these materials are listed in Table 1 below:

TABLE 1

| Element Name | Isotope |
|---|---|
| Boron | B-10 |
| Hydrogen | H-1 |
| Neon | Ne-21 |
| Sodium | Na-23 |
| Sulphur | S-32 |
| Chlorine | Cl-35; Cl-36; Cl-37 |
| Argonne | Ar-36; Ar-39; Ar-40; |
| | Ar-41 |
| Potassium | K-39; K-40; K-41 |
| Calcium | Ca-40; Ca-41; Ca-42; |
| | Ca-43; Ca-44; Ca-45; |
| | Ca-46; Ca-48 |
| Scandium | Sc-45; SC-46 |

Thermal conductors having a thermal conductivity of at least 10% of water thermal conductivity at 100 degrees C. at sea level include:

TABLE 2

| | | | | |
|---|---|---|---|---|
| Phosphorus | 0.00235 | W/cmK | P | 15 |
| Sulfur | 0.00269 | W/cmK | S | 16 |
| Iodine | 0.00449 | W/cmK | I | 53 |
| Astatine | 0.017 | W/cmK | At | 85 |
| Selenium | 0.0204 | W/cmK | Se | 34 |
| Tellurium | 0.0235 | W/cmK | Te | 52 |
| Neptunium | 0.063 | W/cmK | Np | 93 |
| Plutonium | 0.0674 | W/cmK | Pu | 94 |
| Manganese | 0.0782 | W/cmK | Mn | 25 |
| Bismuth | 0.0787 | W/cmK | Bi | 83 |
| Mercury | 0.0834 | W/cmK | Hg | 80 |
| Americium | 0.1 | W/cmK | Am | 95 |
| Californium | 0.1 | W/cmK | Cf | 98 |
| Nobelium | 0.1 | W/cmK | No | 102 |
| Curium | 0.1 | W/cmK | Cm | 96 |
| Lawrencium | 0.1 | W/cmK | Lr | 103 |
| Fermium | 0.1 | W/cmK | Fm | 100 |
| Einsteinium | 0.1 | W/cmK | Es | 99 |
| Berkelium | 0.1 | W/cmK | Bk | 97 |
| Mendelevium | 0.1 | W/cmK | Md | 101 |
| Gadolinium | 0.106 | W/cmK | Gd | 64 |
| Dysprosium | 0.107 | W/cmK | Dy | 66 |
| Terbium | 0.111 | W/cmK | Tb | 65 |
| Cerium | 0.114 | W/cmK | Ce | 58 |
| Actinium | 0.12 | W/cmK | Ac | 89 |
| Praseodymium | 0.125 | W/cmK | Pr | 59 |
| Samarium | 0.133 | W/cmK | Sm | 62 |
| Lanthanum | 0.135 | W/cmK | La | 57 |
| Europium | 0.139 | W/cmK | Eu | 63 |
| Erbium | 0.143 | W/cmK | Er | 68 |
| Francium | 0.15 | W/cmK | Fr | 87 |
| Scandium | 0.158 | W/cmK | Sc | 21 |
| Holmium | 0.162 | W/cmK | Ho | 67 |
| Lutetium | 0.164 | W/cmK | Lu | 71 |
| Neodymium | 0.165 | W/cmK | Nd | 60 |
| Thulium | 0.168 | W/cmK | Tm | 69 |
| Yttrium | 0.172 | W/cmK | Y | 39 |
| Promethium | 0.179 | W/cmK | Pm | 61 |
| Barium | 0.184 | W/cmK | Ba | 56 |
| Radium | 0.186 | W/cmK | Ra | 88 |
| Polonium | 0.2 | W/cmK | Po | 84 |
| Titanium | 0.219 | W/cmK | Ti | 22 |
| Zirconium | 0.227 | W/cmK | Zr | 40 |
| Hafnium | 0.23 | W/cmK | Hf | 72 |
| Rutherfordium | 0.23 | W/cmK | Rf | 104 |
| Antimony | 0.243 | W/cmK | Sb | 51 |
| Boron | 0.274 | W/cmK | B | 5 |
| Uranium | 0.276 | W/cmK | U | 92 |
| Vanadium | 0.307 | W/cmK | V | 23 |
| Ytterbium | 0.349 | W/cmK | Yb | 70 |
| Strontium | 0.353 | W/cmK | Sr | 38 |
| Lead | 0.353 | W/cmK | Pb | 82 |
| Cesium | 0.359 | W/cmK | Cs | 55 |
| Gallium | 0.406 | W/cmK | Ga | 31 |
| Thallium | 0.461 | W/cmK | Tl | 81 |
| Protactinium | 0.47 | W/cmK | Pa | 91 |
| Rhenium | 0.479 | W/cmK | Re | 75 |
| Arsenic | 0.502 | W/cmK | As | 33 |
| Technetium | 0.506 | W/cmK | Tc | 43 |
| Niobium | 0.537 | W/cmK | Nb | 41 |
| Thorium | 0.54 | W/cmK | Th | 90 |
| Tantalum | 0.575 | W/cmK | Ta | 73 |
| Dubnium | 0.58 | W/cmK | Db | 105 |
| Rubidium | 0.582 | W/cmK | Rb | 37 |
| Germanium | 0.599 | W/cmK | Ge | 32 |
| Tin | 0.666 | W/cmK | Sn | 50 |
| Platinum | 0.716 | W/cmK | Pt | 78 |
| Palladium | 0.718 | W/cmK | Pd | 46 |
| Iron | 0.802 | W/cmK | Fe | 26 |
| Indium | 0.816 | W/cmK | In | 49 |
| Lithium | 0.847 | W/cmK | Li | 3 |
| Osmium | 0.876 | W/cmK | Os | 76 |
| Nickel | 0.907 | W/cmK | Ni | 28 |
| Chromium | 0.937 | W/cmK | Cr | 24 |
| Cadmium | 0.968 | W/cmK | Cd | 48 |
| Cobalt | 1 | W/cmK | Co | 27 |
| Potassium | 1.024 | W/cmK | K | 19 |
| Zinc | 1.16 | W/cmK | Zn | 30 |
| Ruthenium | 1.17 | W/cmK | Ru | 44 |
| Carbon | 1.29 | W/cmK | C | 6 |
| Molybdenum | 1.38 | W/cmK | Mo | 42 |
| Sodium | 1.41 | W/cmK | Na | 11 |
| Iridium | 1.47 | W/cmK | Ir | 77 |
| Silicon | 1.48 | W/cmK | Si | 14 |
| Rhodium | 1.5 | W/cmK | Rh | 45 |
| Magnesium | 1.56 | W/cmK | Mg | 12 |
| Tungsten | 1.74 | W/cmK | W | 74 |
| Calcium | 2.01 | W/cmK | Ca | 20 |
| Beryllium | 2.01 | W/cmK | Be | 4 |
| Aluminum | 2.37 | W/cmK | Al | 13 |
| Gold | 3.17 | W/cmK | Au | 79 |
| Copper | 4.01 | W/cmK | Cu | 29 |
| Silver | 4.29 | W/cmK | Ag | 47 |

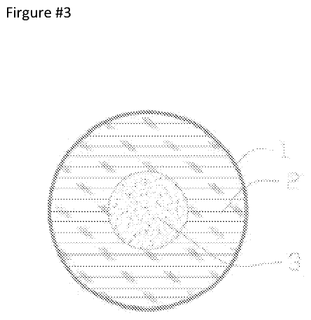

While any combination of the foregoing may be employed to produce particles of the neutron absorbent having the neutron absorption cross section greater than or equal to Boron comprising at least 19.7% of Boron-10 isotope, and the thermal conductor having a thermal conductivity of at least 10% of water thermal conductivity at 100 degrees C. at sea level, it is noted that some of the foregoing are exceptionally hazardous materials, which weigh against their preferred use. An additional constraint is that the particles have a density of at least 0.9982 g/mL and not more than 2.0 g/ml. Some embodiments have the particles being a composite, and one—but not the only—arrangement is illustrated in FIG. 3.

FIG. 3 provides an indication of an exterior layer 1, intermediate layer 2, and core 3. For example, the particles can include a metal as the exterior layer 1, a glass intermediate layer 2, and inert gas as the core. This and other configurations are discussed below.

### Example 1—Glass

There can be one or more glasses, one or more metals, and/or one or more inert gasses. The glass can be borosilicate glass—a type of glass with the main glass-forming constituents being silica and boron oxide. Borosilicate glasses have very low coefficients of thermal expansion (˜3×10-6/° C. at 20° C.), making them resistant to thermal shock, more so than other common glasses. Glasses, such as borosilicate glass, are commercially referred to as Pyrex™ glass, and borosilicate glasses are sold under such trade names as Simax™, Suprax™, Kimax™, Pyrex™, Endural™, Schott™, or Refmex™. Such glasses already have an amount of Boron as part of their chemical makeup, making them notably suitable for some embodiments herein. More generally, glass formulations can be adjusted so the interactions of the above-mentioned ranges combine to define the glass formulations and configurations as may be desired in the particular embodiment of interest. Some embodiments can use as a glass formulation the glass recycled from old TV's and monitors (CRT glass) because of the additives in this glass which minimize irradiation exposure to humans by x-rays from the cathode ray components. This glass is suitable, in some embodiments, for use as the glass component herein, after being melted down and reformed as discussed below.

Illustratively, with respect to FIG. 3, the particles can include a filling that includes, or primarily includes an inert gas 3, such as Helium, e.g. in the core 3. The core 3 can be defined as at least one bubble, e.g. in borosilicate glass 3 enriched with Boron-10 isotope, which in turn is within metal coating 1. The internal gas for the additive composite bead may be a single bubble located at the center of the glass matrix, or as a gas dispersed throughout the glass matrix in a plethora of smaller bubbles, the sum comprising the same volume as the single bubble configuration, as discussed below.

### Example 2—Bubble

Illustratively, again, the glass of the composite can be a borosilicate glass formed into beads and layered. In some embodiments, the beads can have at least one bubble filled or primarily filled with at least one inert gas such as Helium. The beads can have a layer of a metal, such as an outer layer of metal illustratively coating with as metal layer typically produced by vapor deposition or other commercially available coating processes. The metal can be one of the metals listed above, such as Chromium and/or Molybdenum. The borosilicate glass can be located between the at least one bubble and the outer layer. While the composite can have whatever configuration is desired for the particular requirements of an embodiment, having the neutron absorbent and thermal conductor as may be desired for a particular application, illustratively for teaching purposes, consider the following sub examples below.

### Example 2A—At Least One Bubble

A bubble in the glass can be made in many ways, one of which includes essentially blowing molten glass bubbles, sealing the bubbles, and then cooling the bubbles. The bubbles can be blown with, or primarily with, an inert gas such as Helium, with the inert gas being pumped through the middle of the cylinder from the feed end of the tube (e.g., via a port in the die). As the cylinder is being ejected, the inert gas is thereby in the molten cylinder, forming a tubular structure containing the inert gas. Sheering an end of the tubular structure, ejecting more of the molten glass tubular structure with the inert gas therein, and then sheering another end seals an internal bubble containing or primarily containing the inert gas between the wall of the tube and the sheered ends, thereby forming a bubble. Cooling the bubble can be carried out in part by gravity tumbling the bubble along a ramp to help round edges of the bubble as the bubble solidifies into a glass bubble containing or primarily containing the inert gas. Additional cooling can be carried out as usual for cooling glass. For a bubble containing more than one such bubble, multiple ports can be used to eject the inert gas into the molten glass as it is ejected.

Alternatively, a molten tube of glass can be ejected from a die into an inert gas environment. As above, sheering an end of the tube within inert gas environment, sheering end seals an internal bubble containing or primarily containing the inert gas between the wall of the tube and the sheered ends, thereby forming a bubble. Again, cooling the bubble can be carried out in part by gravity tumbling the bubble along a ramp to help round edges of the bubble as the bubble solidifies into a glass bubble containing or primarily containing the inert gas; additional cooling can be carried out as usual for cooling glass, resulting in glass beads containing at least one glass bubble.

In sum, illustratively then, composite particles (beads) can be fabricated using a number of processes, including forming at least one bubble within a layer of borosilicate glass (ceramic, and/or aggregate as discussed below). Note that FIG. 3 is not the only configuration possible as the glass bead can be doped and/or coated with a suitable neutron absorber as listed above, and indeed some configurations need not have a core, such as where a bead is formed from a froth or foam of inert gas, as discussed below.

### Example 2B—Foam

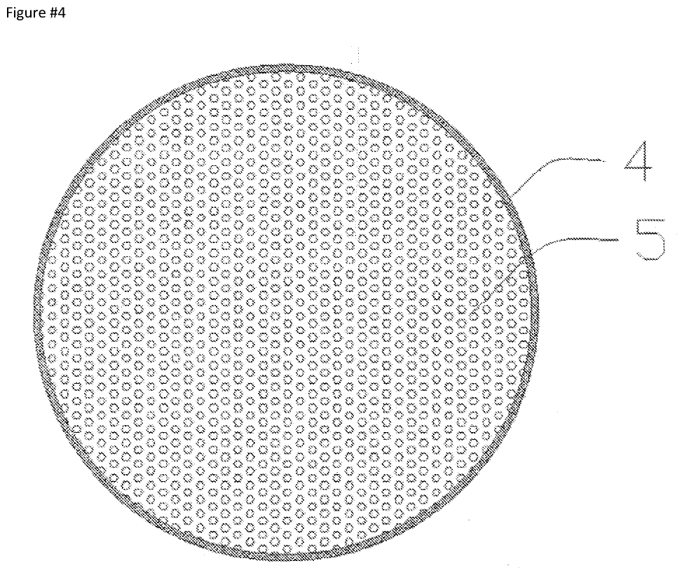

As illustrated in FIG. 4, the inert gas or gasses of interest can be injected into a batch of molten glass, such as the above-mentioned borosilicate glass to produce a froth. The froth is ejected from a die to produce cylindrical ejection that is sheered to produce glass beads containing the froth that in turn contains or primarily contains the inert gas. The beads are rounded, cooled, and coated and/or doped as above.

### Example 3—Amrezate

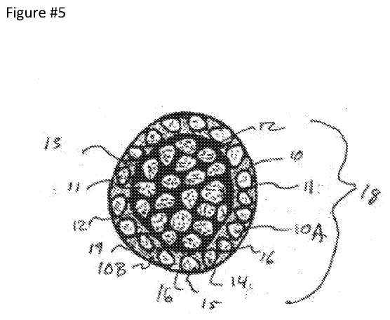

As illustrated in FIG. 5, particles can be formed as aggregate beads, for example, by using techniques disclosed in U.S. Pat. No. 5,628,945, incorporated by reference in its totality. The process includes mixing particles of a first powder 10 and a triggerable granule facilitator 11 to form first microcapsules 12, each having a core comprising one or more of the particles 10 and a coating of the facilitator 11; triggering the facilitator 11 to form granules 13 (one shown in FIG. 5) of the microcapsules 12. Mixing particles of a second powder 10A with the facilitator 11 (or another facilitator) to form second microcapsules 16, each having a core 15 of at least one of the particles of the second powder 10A and a coating of the facilitator 11 (or another facilitator); and mixing the first and the second microcapsules 12 and 16 prior to a triggering step, or retriggering the facilitator 11, to form a combination 18 of the microcapsules 12 and 16. As illustrated in FIG. 4, there can be another facilitator 19 that may or may not contain other particles 10B, depending on the embodiment of interest. The combination 18 is heated sufficiently to remove at least a portion of the facilitator(s) 11 and form an aggregate. The facilitator 11 can, but need not always, be one or more metalorganic soap; similarly, the first powder and the second powder can be particles of a ceramic, metal, organic, plastic, polymer, the glass, and/or the glass beads bubbled or foamed, described above, etc. The process can include third or more microcapsules to produce a distribution of the neutron absorbent(s) and thermal conductor(s) as may be desired.

### Example 3—Ceramic

In another example, the particles are layered as in FIG. 3 or foamed as in FIG. 4, with at least one bubble of helium or another inert gas or mixture of them so that the bubbles are at least primarily filled of inert gas, an outer layer as discussed above, e.g., chromium and/or molybdenum. A ceramic containing the neutron absorbent is located between said at least one bubble and the outer layer, and as above, the aggregate particle may or may not be doped, depending on the embodiment of interest.

For example, in FIG. 3—that area which is intermediate the internal bubble(s) and the outer metal layer, can be comprised of a ceramic. Ceramic materials are suitable because of their structural toughness, good thermal conductor, reliable physical properties, and the ability to contain a suitable neutron absorber such as boron. Several different forms of ceramics are suitable where ceramic materials ranges from highly oriented to semi-crystalline, vitrified, or completely amorphous (e.g., glasses), and illustratively suitable are non-crystal and ceramics. But noncrystalline ceramics, being glass, tend to be formed from melts. The glass is shaped when either fully molten, by casting, drop casting, or when in a state of toffee-like viscosity, by methods such as blowing into a mold. If later heat treatments cause this glass to become partly crystalline, the resulting material is known as a glass-ceramic. Specific examples for ceramics include boron oxide and boron nitride. In these two cases, the B-10 isotope making up such as 19.7% or more of the boron inventory provides a suitable neutron absorber.

### Example 4—Plastic or Polymer

In another example, the particles are formed employing a plastic or polymer such as polyetheretherketone or polyetherimid. A neutron absorbent can be incorporated into the plastic or polymer either as an aggregate or as an isotope of the base chemistry of the plastic or polymer. The plastic or polymer may be used to coat an internal bubble or bubbles or foam. However, a polymeric configuration can be carried out without such bubble(s) or foam, e.g., where the particle is of low enough density and meets the structural requirements for the embodiment at issue. However, in some cases, the plastic or polymer may then be coated with a hard and low friction coating, such as chromium or molybdenum as described herein. Alternatively, the plastic or polymer may have a sufficient hardness, friction coefficient, and thermal conductivity suitable for the application negating the need for an additional coating.

### Example 5—Mixture

In yet another example, the particles include a mixture of the foregoing. That is, to configure a totality of particles for the embodiment of interest, the particles can be a mixture of two or more of the above-mentioned configurations.

### Other Characteristics of Interest

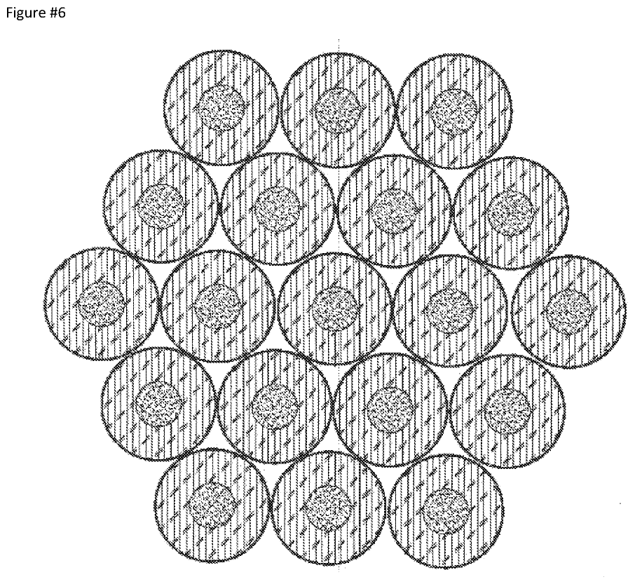

Depending on the embodiment of interest, the particles, when packed in maximum packing configuration of face center cubic array or hexagonal closest packing, as illustrated in FIG. 6, can have a gross density less than or equal to the density of water. Note that in some cases, particles of a greater gross density can be used within the limits of the structural requirements of the reactor vessel and its margin of safety, but such is not typically of choice. Typically, the particles can be individually somewhat heavier than the water or other coolant of interest.

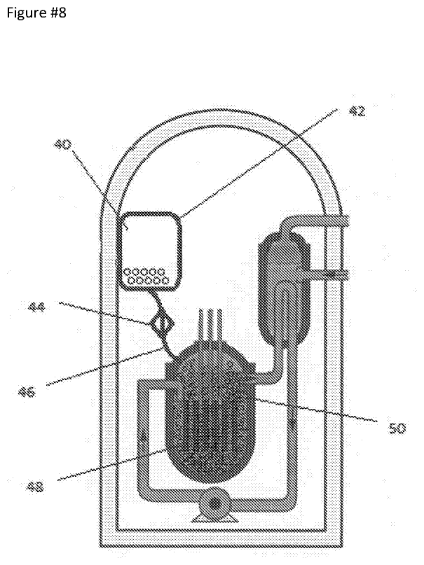

This density will allow the particles to be poured under water (coolant) into a reactor vessel containing the nuclear material and displace some of the water (coolant). When the particles are fully injected into the reactor core, the beads can be in a close pack formation to support the fuel or material, as illustrated in FIG. 8. In this close pack formation, the particles can be collectively lighter than the water (coolant), so as not to add more than the water (coolant) weight to the vessel structure.

Generally, the particles can be hard (e.g., Chromium), providing for low friction and low deformability, with a hardness rating of typically greater than 65 on the Rockwell C scale. However, for certain applications, a softer particle, coating, or exterior, such as lead, may be desirable. Generally though, the particles can, but need not always, have sufficient structural integrity, size, and friction that, when packed in random maximum density packing, collectively resist deflection and/or displacement of forces between 10 g's and 40 g's, and indeed, where desired, at least some of the particles deformably cushion against the mechanical shocks—sometimes at least some of the particles are deformable sufficient to cushion against the mechanical shocks beyond 10 g's, in some cases, beyond 100 g's, and in yet other cases, up to and including 60,000 g's depending upon the time duration of the shock loading.

Typically, the particles include particles that are spherical shaped, and/or spheroid shaped, and/or ellipsoid shaped and have a dimension in the range of 0.1 mm to 20 mm. In many cases the particles are not completely or even substantially metal.

If so desired, the particles can have a static coefficient of friction between 0.02 and 0.75, and in some cases, the additive particles behave as a non-Newtonian fluid.

Embodiments can be carried out so that the particles are configured to provide any combination of:

1. a structural support;

2. a thermal conductivity to reduce fuel rod temperature sufficiently to allowing vessel and core re-flooding and reopening the vessel for inspection and management (e.g., below 150 C degrees, and in other cases below 150 degrees C.);

3. provide a nuclear fission shut-down margin.

The selection of, and amounts of, or ranges for, structural support, thermal conductivity, nuclear fission shut-down margin, and integrity can be selected the particular implementations as may be desired.

Additionally, the particles can, if so desired, be configured to withstand high radiation levels for a long time (e.g., 100 years and better still, 1000 years, with a total absorbed dose in the range of 10 Teragray (Tgy)) and

The selection of, and amounts of, or ranges for, hardness and strength, and the duration for withstanding the radiation can be tailored to the particular implementations as may be desired.

Generally, the particles should not be so heavy as to make the reactor vessel over tax its mechanical design rating. The particles can be small enough to flow into the spaces around the fuel or nuclear material and provide support for the fuel or nuclear material, but not so small and/or shaped that they make the reactor core or vessel too heavy or make it impractical to remove the particles for inspecting the contents of the core. The particles therefore should be reasonably round—round enough to permit flowing into the spaces adjacent to the fuel or nuclear material in the core.

Illustratively, as a teaching example, consider the beads being spherically or ellipsoidally shaped, having an outer diameter of 0.090″ (2.286 mm). The particles can be enriched in Boron-10 isotope for good thermal neutron absorption and thermal shock resistance. Each of the beads of this diameter can be configured as one or more bubbles so that the particle density is about 110% the density of water—just slightly heavier than water individually, but in a close pack formation, lighter than water as a group, given equivalent volume. The bubbles can be filled or primarily filled with one or more inert gasses, e.g. such as Helium. The particles can have a coating of perhaps 200 microns of a metal (such as Chromium, Molybdenum, or a combination thereof), which facilitates thermal conductivity without presenting significant thermal expansion. Illustratively, the beads can, but need not, be as follows.

Outer diameter: 2.286 mm

Glass bubble: 0.04909 mm

Glass thickness: 0.89391 mm

Coating, i.e., Chrome thickness: 0.2 mm.

The foregoing is merely illustrative and would be adjusted as may be desired in one implementation or another, for example, to optimize neutronic, thermal, structural, and cost performance. Indeed, in another embodiment, consider a 30-micron coating in the Table 3 as follows:

TABLE 3

| | | | |
|---|---|---|---|
| Density of water | 0.001 | g/mm\hat{ }3 | |
| Density of borosilicate glass | 0.0023 | g/mm\hat{ }3 | |
| Density of He | 1.78E−07 | g/mm\hat{ }3 | |
| Density of Chrome plate | 0.0072 | g/mm\hat{ }3 | |
| Bead radius (r4) | 1.143 | Mm | |
| Bead diameter | 2.286 | Mm | |
| Chrome thickness | 0.03 | Mm | |
| Mass of water drop | 0.014386 | G | |
| Target mass at +10% | 0.015825 | G | |
| HE radius | 0.45 | Mm | |
| He diameter | 0.9 | Mm | |
| He mass | 6.79E−08 | G | |
| Glass inner/outer radius | 0.45 | 1.113 | Mm |
| Glass outer diameter | 2.226 | Mm | |
| Glass mass | 0.012405 | G | |
| Glass thickness | 0.663 | Mm | |
| Chrome inner/outer radius | 1.113 | 1.143 | |
| Chrome outer diameter | 2.286 | Mm | |
| Chrome mass | 0.003454 | G | |
| Bead total mass | 0.015859 | G | |

More generally, though, the additive can include any of the non-gaseous neutron absorbents having a neutron absorption cross section greater than Boron comprising 19.7% of Boron-10 in a combination with and a thermal conductor such that the combination has a thermal conductivity of at least 10% of water thermal conductivity, the combination providing a cushion against mechanical shocks. The additive can be any of mechanically, chemically, and atomically stable at 100 degrees C., e.g., for more than 100 years. The additive can comprise a glass, metal, ceramic, polymer, or aggregate particles, and in some embodiments, additive behaves as a non-Newtonian fluid which provides some of the cushion against the mechanical shocks. In some but not all cases, the glass is borosilicate glass configured to have an internal gas bubble, or bubbles, that contain or primarily contain one or more inert gases such as Helium. The additive can comprise a glass, metal, ceramic, polymer, or aggregate particles, and in some embodiments, a portion of the additive partially or completely deforms which provides some of the cushion against the mechanical shocks. In a bubble configuration, the glass beads can, but need not, have an outer diameter in the range of 0.05 mm to 20.0 mm, a wall thickness between the bubble and an outer diameter of the bubbles is in the range of 0.100 mm to 2.75 mm, and/or be spherically shaped and have a static coefficient of friction between 0.02 and 0.75. In some but not all cases, the glass beads can have sufficient structural integrity, size, and friction that, when packed in random maximum density packing, collectively resist deflection and/or displacement of a force of 20 gs.

In some embodiments, the glass beads can each have a density greater than or equal to the density of water, and if so desired, the glass beads, when packed in a maximum packing configuration of face centered cubic array or hexagonal closest packing, have a density less than the density of water. If a metallic coating, such as Chromium and/or Molybdenum, is employed for the beads, the coating can supplement the thermal conductivity of the beads such that the thermal conductivity is at least 10% of the water thermal conductivity.

Illustratively as in FIG. 8, the additive herein disclosed can be used as a core 50 additive to protect nuclear material such as nuclear fuel, and spent nuclear fuel in a nuclear reactor core. The additive can be “poured” into the reactor core and fill the reactor vessel at the command of the operator the system instrumentation.

From another perspective, there is herein provided a composition—a nuclear fuel environment additive including particles including a neutron absorbent, the absorbent having a neutron absorption cross section greater than or equal to Boron e.g. comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml. The particles can be a composite material.

In any one of the embodiments herein, the composite material includes metal, glass, and at least one inert gas.

In any one of the embodiments herein, the particles are layered, with at least one bubble of helium, an outer layer of chromium and/or molybdenum, and borosilicate glass between said at least one bubble and the outer layer.

In any one of the embodiments herein, the particles are layered, with at least one bubble of helium, an outer layer of chromium and/or molybdenum, and ceramic containing the neutron absorbent between said at least one bubble and the outer layer.

In any one of the embodiments herein, the particles include an aggregate, with at least one bubble of helium, an outer layer of chromium and/or molybdenum, and borosilicate glass and/or a ceramic containing the neutron absorbent between said at least one bubble and the outer layer.

In any one of the embodiments herein, the particles, when packed in maximum packing configuration of face centered cubic array or hexagonal closest packing, have a gross density less than or equal to the density of water.

In any one of the embodiments herein, the particles include particles that have a static coefficient of friction between 0.02 and 0.75.

In any one of the embodiments herein, the additive behaves as a non-Newtonian fluid.

In any one of the embodiments herein, the particles have sufficient structural integrity, size, and friction that, when packed in random maximum density packing, collectively resist deflection and/or displacement of forces between 10 g's and 40 g's.

In any one of the embodiments herein, at least some of the particles deformably provide a cushion against the mechanical shocks.

In any one of the embodiments herein, at least some of the particles provide a deformable cushion against the mechanical shocks beyond 10 g's.

In any one of the embodiments herein, the particles include particles that are spherical shaped, and/or spheroid shaped, and/or ellipsoid shaped and have a dimension in the range of 0.1 mm to 20 mm.

In any one of the embodiments herein, the neutron absorption cross section is provided by Boron comprising at least 19.7% of Boron-10 isotope.

In any one of the embodiments herein, the particles produced from at least one waste stream or recycled product.

In any one of the embodiments herein, the particles include a bubble at least primarily filled with Helium.

In any one of the embodiments herein, at least some of the particles have a wall thickness between at least one bubble and an outer particle diameter, in the range of 0.10 mm to 15 mm.

In any one of the embodiments herein, the particles include more than one bubble at least one said bubble being primarily filled with Helium.

In any one of the embodiments herein, the particles include a foam of bubbles at least some of the bubbles being primarily filled with Helium.

In any one of the embodiments herein, the particles comprise borosilicate glass.

In any one of the embodiments herein, the thermal conductor comprises a metallic coating on the particles.

In any one of the embodiments herein, the metallic coating comprises Chromium and/or Molybdenum.

With respect to the foregoing embodiments, there can be a storage reservoir adapted to contain a composition and a transport mechanism adapted to receive the composition from the storage reservoir, and transport the composition to a location of a loss of normal heat sink event and/or a loss of normal coolant event, and to disperse the composition so as to palliate the loss of the normal heat sink event and/or the loss of normal coolant event.

Additionally, there is herein provided a process of using the nuclear environment additive, the process including combining the neutron absorbent and the thermal conductor identified in any of the foregoing composition embodiments.

Yet in addition, there is herein provided a process of making the nuclear environment additive, the process including combining the neutron absorbent and the thermal conductor identified in any one of the foregoing composition embodiments

Furthermore, there is herein provided a product produced by any one of the aforesaid processes of making.

Also, there is herein provided a product a cask or vessel containing the product or composition.

Yet further in addition, there is herein provided an article or apparatus comprising a cask or vessel containing in any one of the foregoing composition embodiments.

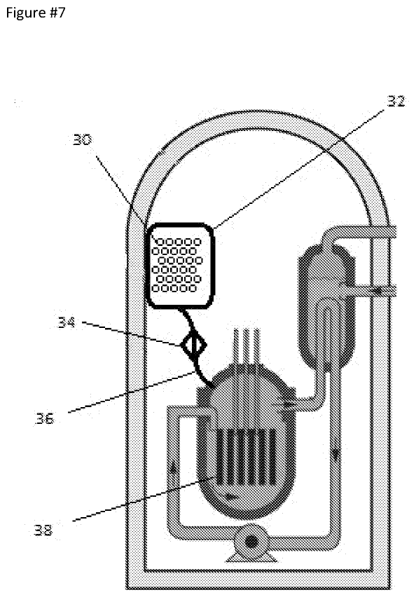

In any of the embodiments above, the additive can be placed into the reactor core through existing equipment as shown in FIG. 7. Because the timing of reactor accidents involving loss of coolant or loss of heat sink events is rarely predicted, a suitable inventory of the particles can be made available either onsite or relatively close by for rapid use by the nuclear reactor operator should the need arise. For a power reactor system, the inventory would be in the range of 1400 cubic feet of material.

Storage of the particles can be within the containment vessel of the nuclear reactor located the position such that the particles can be injected into the reactor core at the command of the operator, the control computer, system and instrumentation, or responsive to physical conditions such as through a burst disk or checked valve driven by system pressure.

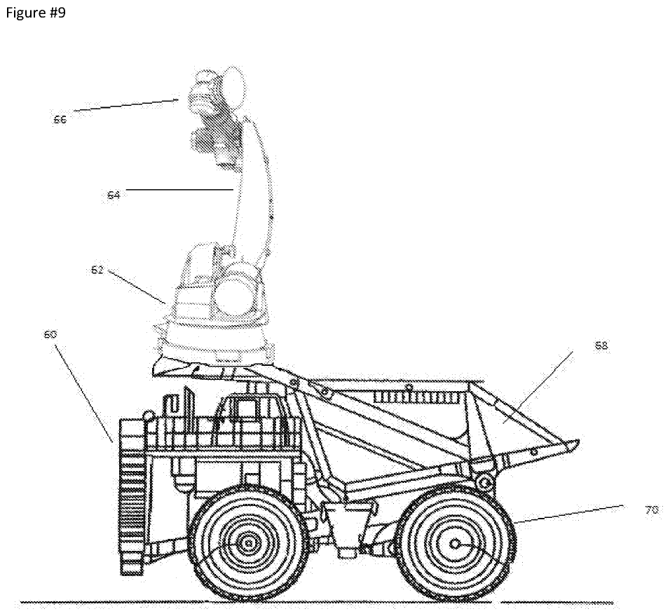

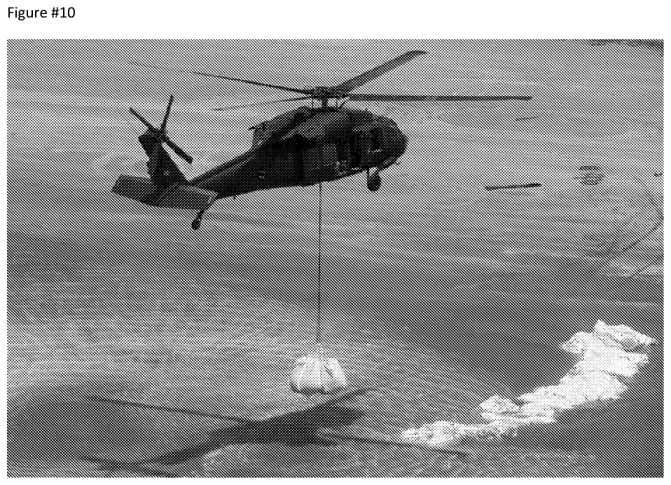

Alternatively, the particles can be transported from a storage inventory to the reactor vessel via a robotic or drone system—FIGS. 9 and 10—in cases where the reactor is heavily damaged and existing mechanism(s) are no longer functional. In these cases, the use of robotic transport (FIG. 8) or robotic aircraft (FIG. 9) can be used. See also U.S. Pat. Nos. 6,588,701, and 8,381,826, both incorporated by reference. Here, the particles are sourced from a location not within the nuclear reactor containment and are transported to the damaged core area. These cases are illustrated by the accidents at Chernobyl and Fukushima.

Note that some embodiments herein are directed to compositions consisting essentially as set forth, which is not to be confused with embodiments comprising as set forth. Replacement or alteration of the bead components or change in chemistry or structure will alter its performance and can in some cases negate its capability and/or functionality.

For example, replacement or alteration of the neutron absorbent will limit the composition's ability to quench fission reactions and the further production of heat generating radio nuclides. Reduction in the amount of B-10 will reduce the beads effectiveness.

Also for example, the composition, e.g., bead, structure is designed with a thermal conductivity sufficient to link the nuclear material to the surrounding structure and ultimate heat sink. Alteration of the composition which reduces the thermal conductivity will reduce the effectiveness of the composition to remove energy of the nuclear material and thus its temperature.

Additionally for example, the composition, e.g. bead, is designed to have a density which approximates the reactor coolant. If the composition of the bead is changed such that the bead density is raised above the limits described, use of the bead may overstress the system structure either statically or dynamically. Lowering of the bead density below the limits described will call the beads to float and not migrate throughout the nuclear material structure when released into the system. This will prevent the beads from being effective.

Generally, consider logic for release or injection of the composition/additive/beads/reactor coolant additive—e.g., beads. A control system can be used for deployment of the composition. The control system can be arranged to terminate significant or large off nominal events, such as loss-of-coolant accidents in power reactive systems where such events can lead to fuel damage or worse. In this teaching example, consider a control system adapted to protect the fuel from damage, e.g., so as to prevent an event from exceeding a nucleate boiling (DNB/DNBR) condition or otherwise mitigate the possibility of a release of radionuclides and fission products into the environment. Reactor components and systems which have been damaged or stressed by a reactor transient event or accident can be repaired or replaced as long as fuel damage or significant fuel damage has not occurred. Once fuel damage has occurred the complexity and costs associated with repair is multiplied by many thousands of times. Examples are Three Mile Island, Chernobyl and Fukishima. So in many embodiments herein, it is imperative, that during a reactor transient or accident, actions be taken to quickly terminate the transient and prevent fuel damage.

However, the release or injection of the reactor accident mitigation beads into the reactor system will effectively preclude future reactor operations without substantial maintenance activities to remove the beads. In addition, the nature of the beads is such that they may damage pumps, valves, and other equipment during their use. Therefore, processes herein include refurbishment prior to return to operation.

In any case, the injection or release of the beads into the reactor core should be performed judiciously, and in some but not all embodiments, only when fuel damage is eminent or is already occurring. (In some other cases, even after the damage or worse has occurred.)

In some embodiments, the beads would be injected or released into the reactor core when all or most other engineered safeguards functions have been expended, and preferably before fuel damage has occurred.

The reactor accident mitigation beads can, but need not always, have any of three features:

1. The beads ensure proper heat sink for the fuel, e.g., by creating a direct conductive and radiative thermal transport medium. In this manner, energy generated in the fuel can be transported away from the fuel and thus limit the temperature of the fuel structure to be within design values. In addition, once in place, where the beads have generally round shape, spaces between the beads provide fluid pathways so that reactor coolant can be reinjected into the reactor core and the fuel reflooded. Once injected or released, the beads will not change phase or otherwise leak out of the reactor core at temperatures comparable to such coolants as water. The continued loss of reactor coolant in post-accident conditions can itself lead to fuel damage (e.g., Three Mile Island, Fukishima).

2. The beads are composed to be sufficiently powerful neutron absorbers that they will effectively quench energy production by fission and neutron capture reactions. While the existing reactivity control systems of the reactor will almost always achieve a subcritical configuration, they may only provide limited shutdown margin with k-eff which may be close to 1.0. K-eff's closer to 1.0 allow for a substantial population of second generation neutrons to be born leading to additional fissions and neutron capture radiological events. These secondary events continue to inject energy into the fuel, complicating post-accident heatsink management, and maintaining acceptable fuel temperatures. The beads can be configured such that injection or release of the beads into the reactor core will lower the k-eff, e.g., below 0.4, and dramatically reduce secondary neutron population.

3. Injection/release of the beads provides a solid mechanical support for the fuel structure by creating a mechanical link between the reactor vessel and the fuel element or fuel rod. Nuclear fuel is typically quite fragile and delicate with very limited structural material inherent in its design. This is a natural consequence of reactor design in order that structural materials do not interfere with neutron field during operation. However, many times during reactor transients or accidents, fuel is subjected to mechanical forces that may be beyond its design limit, thus leading to fuel damage. Once injected or released, the beads have the ability to provide additional mechanical support, assisting in maintaining the mechanical integrity of the fuel.

The decision to inject/release the beads into the reactor core can be carried out so as to implement a required precision with regard to timing and commitment. Injecting/releasing the beads will result in a substantial delay and cost to return the unit back to service. While this impact is far less than that resulting in fuel damage, the impact is more significant than the typical resetting of engineered safeguards after the termination of a lesser transient. Therefore, this may pose be a very difficult decision for human operators whose livelihood may depend on the commercial operation of the reactor. In addition, the decision to inject/release the beads may require a complex analysis of a large number of system parameters in an extremely short period of time. A solution is to establish a decision-making system which does not require human operator input and cannot be prematurely terminated, isolated, or otherwise blocked by the human operator once the system is armed. This ensures the beads will be injected/released at the latest possible moment after all other engineered safeguards systems options have been expended, attuned to activate in certain embodiments before fuel damage has occurred.

Such a Bead Injection/release Decision System (BIDS) can, but need not always, perform certain computations, typically simultaneously, continuously, and in real time. For example, the BIDS can continuously compute how close the fuel or reactor core is to a departure from nucleate boiling (DNB). This metric is the departure from nucleate boiling ratio (DNBR). This is the ratio of the heat flux needed to cause departure from nucleate boiling to the actual local heat flux of a fuel rod. Typically, this is a temperature/pressure/flow velocity relationship for the reactor coolant. Reactor power and fuel rod heat generation can be required as well.

However, many times during the operation of a nuclear reactor and particularly during accident conditions, the local fluid and fuel temperature conditions are not well known. Therefore, in some embodiments, a BIDS DNB deterministic calculation or logic can be augmented non-deterministically, e.g., by such as an artificial intelligence (AI) approach.

Such a Bead Injection/release Decision System (BIDS) can, but need not always, compute, e.g., continuously compute, a probability of fuel damage in a future time period, e.g., the next twelve hours (PFD12). For example, the PFD12 calculator is designed to determine the probability (0 to 1) of fuel damage integrated over the next twelve hours by computing thermodynamic and structural dynamic conditions and their proximity to fuel design limits. In addition, errors and uncertainties on this condition are tallied and applied, e.g., in a conservative manner. As with the BIDS calculation, system parameters may not be known with precision. Thus, in some embodiments, the conditional deterministic logic can be non-deterministically augmented in determining PFD12 values.

In some but not all cases, the BIDS uses these two metrics with established set points for the DNB and PFD12 values to determine whether to inject the beads into the reactor core. Once these set points have been reached (both set points have to be met, e.g., by −2/2 auctioneering), the BIDS executes an irrevocable order to inject/release the beads into the reactor core. Recognizing the importance and consequences of the BIDS calculation, it is recommended that multiple independent trains of BIDS calculations be performed with subsequent auctioneering. (Example 2 out of 3). To determine the bead injection/release signal.

For further information, one can consult:

Nucleate Boiling—en.wikipedia.org/wiki/Nucleate_boiling;

Departure from Nucleate Boiling (DNB)—nrc.gov/reading-rm/basic-ref/glossary/departure-from-nucleate-boiling-dnb.html; and

Departure from Nucleate Boiling Ratio (DNBR)—nrc.gov/reading-rm/basic-ref/glossary/departure-from-nucleate-boiling-ratio-dnbr.html.

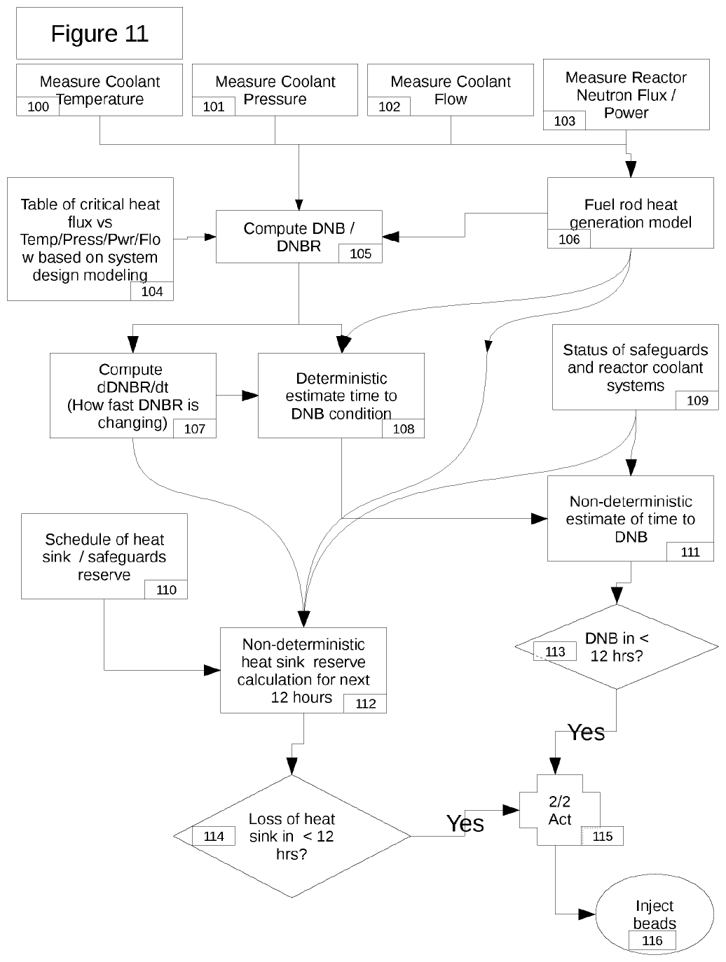

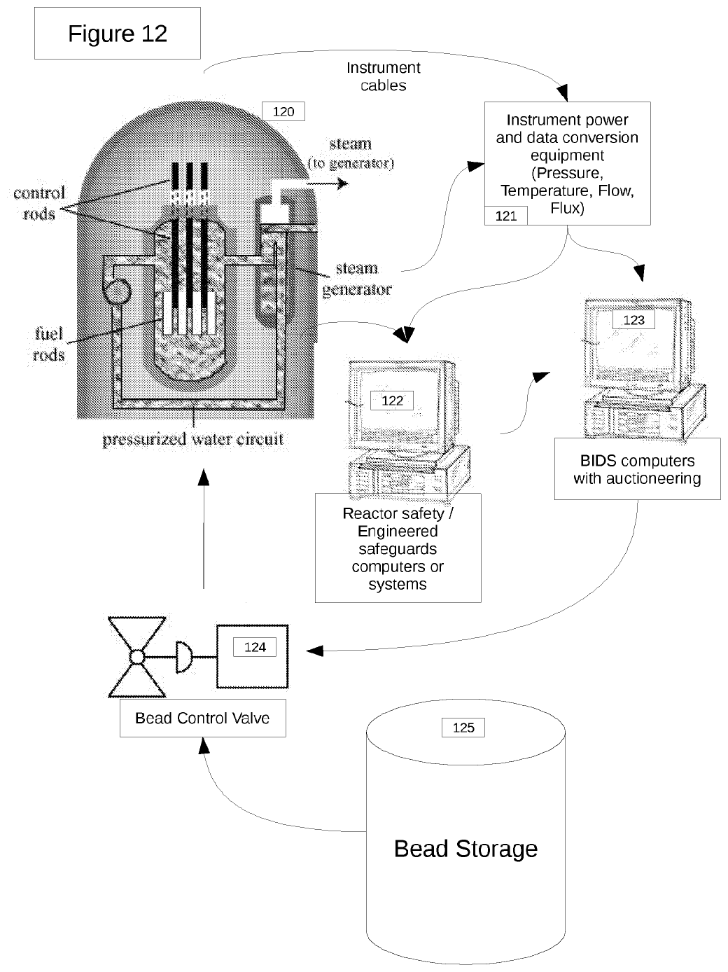

FIG. 11 illustrates the BIDS logic diagram and the sequence of calculations necessary to determine the time at which to inject the beads into the reactor system. This logic can run on the hardware architecture described in FIG. 12.

To compute departure from nucleate boiling (DNB) and the departure from nucleate boiling ratio (DNBR) (item 105), the system first measures coolant temperature (100), coolant pressure (101), coolant flow (102), and reactor power or neutron flux (103). This information is fed into the DNB model package (105) which uses the DNB curves (104) which are produced in the design of the system. The DNB/DNBR model (105) also uses the fuel rod heat generation model (106) to include additional heat sources including fission and radio nuclide decay.

The results of the DNB/DNBR model (105) are fed into the DNB/DNBR derivative model (107) to determine the rate of change of DNB and DNBR conditions.

The results of 107 are added to 106 to make a deterministic computation of how far in the future DNB will occur (108).

The status of the reactor system safeguards and reactor coolant systems is computed and tabulated in 109. This may include information such as tank levels, pump status, power system status, and coolant inventories.

The results of 108 and 109 feed into the non-deterministic model (111) to estimate the time to achieve departure from nucleate boiling. This model uses nondeterministic processes to integrate the input data and make computations that extend beyond deterministic models and emulate the decision making of a human engineer.

The results of 111 are then checked by 113 to determine if DNB will occur within a predetermined time into the future (e.g. 12 hours). If true, the module produces a YES vote.

The schedule of heat sink and safeguards reserves (110) provide the system with base knowledge of the heat sink resources that are available to the safeguards logic, and the information on when these resources would normally be executed.

The results of modules 106, 107, 109, and 110 are fed into a non-deterministic heat sink reserve module 112 which determines the amount of heat sink reserve over a predetermined time into the future (e.g. 12 hours). This module produces a schedule of the heat sink reserve as a function of time.

Module 112 feeds into module 114 which assess whether there is a loss of heat sink condition in the schedule produced by module 112. If true, the module produces a YES vote.

The positive (YES) results of modules 113 and 114 are auctioneered in module 115 to determine if there is a time coincident condition where both 113 and 114 are producing YES votes. If true, the auctioneering module 115 would produce a signal to inject the beads which is processed by the system execution module of 116. Module 116 is design to control the system components needed to execute the bead injection.

FIG. 12 illustrates the hardware architecture that can be used to execute the software and logic structure as detailed in FIG. 11. Or if it is preferred, the logic can be hard wired or partially hard wired. It is well known that programming a computer produces circuitry that essentially is a special purpose computer, and software can be readily implemented in hardware.

In any case, the reactor system (typical) is shown in item 120. This includes the reactor system, the containment, reactivity controls (e.g. control rods) and all of the system safeguards resources. The reactor safeguards and emergency functions are normally handled by the safeguards control system(s), 122.

The reactor system, 120, is outfitted with a variety of sensors and detectors to monitor all of the reactor systems including multiple trains of temperature, flow, pressure, and reactor power. These sensors are typically terminated in the instrument cabinet(s), 121. This cabinet converts the sensor signals into data that is useful in further processing.

The Bead Injection Decision System (BIDS) architecture (FIG. 11) is implemented on the computer(s) of item 123. The BIDS computers get input from the Reactor safety/engineered safeguards systems (122), and the reactor system instrumentation (121). BIDS continually process the information in real time with cycle times of typically less than minute.

The output of BIDS (123) directly drives the Bead Control Valve (124), which on auctioneered command, will release the beads from their storage unit (125) into the reactor system (120).

It is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments, including what is described in the Abstract and the Disclosure and the Industrial Applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1-136. (canceled)

137. A nuclear fuel environment additive, the additive including:
particles made of a composite material including a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml.

138. The additive of claim 137, wherein the composite material includes metal, glass, and inert gas.

139. The additive of claim 138, wherein the particles are layered, with at least one bubble of helium, an outer layer of chromium and/or molybdenum, and borosilicate glass between said at least one bubble and the outer layer.

140. The additive of claim 138, wherein the particles are layered, with at least one bubble of helium, an outer layer of chromium and/or molybdenum, and ceramic containing the neutron absorbent between said at least one bubble and the outer layer.

141. The additive of claim 138, wherein the particles include an aggregate, with at least one bubble of helium, an outer layer of chromium and/or molybdenum, and borosilicate glass and/or a ceramic containing the neutron absorbent between said at least one bubble and the outer layer.

142. The additive of claim 137, wherein the particles, when packed in maximum packing configuration of face center cubic array or hexagonal closest packing, have a gross density less than or equal to the density of water.

143. The additive of claim 142, wherein the particles include particles that have a static coefficient of friction between 0.02 and 0.75.

144. The additive of claim 143, wherein the additive behaves as a non-Newtonian fluid.

145. The additive of claim 144, wherein the particles have sufficient structural integrity, size, and friction that, when packed in random maximum density packing, collectively resist deflection and/or displacement of forces between 10 g's and 40 g's.

146. The additive of claim 145, wherein at least some of the particles deformably provide a cushion against the mechanical shocks.

147. The additive of claim 146, wherein at least some of the particles provide a deformable cushion against the mechanical shocks beyond 10 g's.

148. The additive of claim 147, where the particles include particles that are spherical shaped, and/or spheroid shaped, and/or ellipsoid shaped and have a dimension in the range of 0.1 mm to 20 mm.

149. The additive of claim 137, wherein the neutron absorption cross section is provided by Boron comprising at least 19.7% of Boron-10 isotope.

150. The additive of claim 137, wherein at least some of the particles have a wall thickness between said at least one bubble and an outer particle diameter in the range of 0.10 mm to 15 mm.

151. The additive of claim 137, wherein the particles include more than one bubble at least one said bubble being primarily filled with Helium.

152. The additive of claim 137, wherein the particles comprise borosilicate glass.

153. The additive of claim 137, wherein the thermal conductor comprises a metallic coating on the particles.

154. The additive of claim 153, wherein the metallic coating comprises chromium and/or molybdenum.

155. A process including the steps of:
changing density of a composition including a neutron absorbent, the absorbent having a neutron absorption cross section greater than or equal to Boron comprising at least 19.7% of Boron-10 isotope, and a thermal conductor having a thermal conductivity of at least 10% of coolant thermal conductivity at 100 degrees C. at sea level, combined into the particles that have a density of at least 0.9982 g/mL and not more than 2.0 g/ml, the altering carried out in association with nuclear fuel or nuclear waste in a cask that is not located in a nuclear reactor containment vessel, the cask being a nuclear fuel cask or a spent nuclear fuel cask, the changing carried out by relocating the composition by at least one of the sub steps comprising:
(A) operating a hollow conduit connected to a reservoir to relocate at least some of the particles from a reservoir into the cask, and/or
(B) altering a close pack formation of the particles by effectuating a change from a static coefficient of friction of the particles to a dynamic coefficient of friction of the particles, thereby redistributing the particles within the cask into an altered close pack formation, and/or
(C) removing at least some of the particles from the cask into the reservoir.

156. A process of using a composition, the process including:
locating a composition to release, responsive to a loss of normal heat sink event and/or a loss of normal coolant event, the composition consisting essentially of a neutron absorbent, the absorbent having a neutron absorption cross section greater than or equal to Boron comprising at least 19.7% of Boron-10 isotope, and a thermal conductor having a thermal conductivity of at least 10% of water thermal conductivity at 100 degrees C. at sea level, combined such that the particles have a density of at least 0.9982 g/mL and not more than 2.0 g/ml, the composition at a location, and in a quantity sufficient, to palliate the loss of the normal heat sink event and/or the loss of normal coolant event.
